(19) United States
(12) Patent Application Publication
(10) Pub. No.: US 2006/0086755 A1
(43) Pub. Date: Apr. 27, 2006

(54) Two compartment container adapted to separately hold consumable foodstuffs

(76) Inventors: Donna Roth, Plymouth, MA (US); Henry Roth, Plymouth, MA (US)

Correspondence Address: GARCIA-ZAMOR INTELLECTUAL PROPERTY LAW;ATTN: RUY GARCIA-ZAMOR, 2700 LIGHTHOUSE POINT EAST, SUITE 629, BALTIMORE, MD, 21224, US

(21) Appl. No.: 11/012,452

(22) Filed: Dec. 15, 2004

Related U.S. Application Data
(63) Continuation-in-part of application No. 29/214,964, filed on Oct. 12, 2004.
(63) Continuation-in-part of application No. 29/217,503, filed on Nov. 18, 2004.

(51) Int. Cl. B67D 5/56

(52) U.S. Cl. 222/129

(57) ABSTRACT

A two part container adapted to separately hold consumable foodstuffs. The two part container provides a convenient device for transporting different foodstuffs in a separated fashion using a single container.

### CROSS REFERENCE TO RELATED APPLICATIONS

This application is a continuation-in-part and claims priority to: U.S. Design Patent 29/214,964, filed Oct. 12, 2004; and U.S. Design Patent 29/217,503, filed Nov. 18, 2004; both of the above applications are hereby incorporated by reference herein in their entirety as if fully set forth.

### BACKGROUND

The present invention is generally directed to foodstuff containers and, more specifically, is directed to a two part container adapted to separately hold consumable foodstuff.

Typically, when a liquid foodstuff, such as soda, and a solid foodstuff, such as grapes, are transported to school or work for later consumption, they are transported in separate containers. This often requires that a bag or knapsack be used to carry the multiple containers necessary to transport the desired foodstuffs. When the containers are carried by hand, carrying the various containers can be unwieldy for adults and difficult for children. Additionally, when a child remains home after adults have left and the child is responsible for organizing prepared foods to take with her or him, a child will often forget part of a snack or meal.

It would be advantageous to provide a two part container adapted to separately hold consumable foodstuffs which can either be beverages or food; preferably, at least one of the container parts includes thermal energy storage material to allow the consumable foodstuff in that container part to be chilled or heated.

### SUMMARY

One embodiment of the present invention is directed to a two part container adapted to separately hold consumable foodstuffs. The two part container includes a first container which includes a first container base. A first container sidewall extends from the base to define a first container mouth. The first container sidewall is formed by inner and outer panels. The inner panel and the first container base define a first foodstuff receiving cavity. The outer panel is generally coextensive with and spaced from the inner panel to define a chamber therebetween. Thermal energy storage material is located in the chamber. A second container includes a second container base. A second container sidewall extends from the second container base to define a second container mouth. The second container sidewall and the second container base define a second foodstuff receiving cavity. The first and second containers are detachably engageable to form the two part container.

In another aspect, the present invention is directed to a two part container adapted to separately hold consumable foodstuffs. The two part container includes a first container having a first longitudinal axis. The first container includes a first container base. A first container sidewall extends from the base to define a first container mouth. The first container sidewall defines a first foodstuff cavity. A second container has a second longitudinal axis. The second container includes a second container base. A second container sidewall extends from the second container base to define a second container mouth. The second container sidewall and the second container base define a second food receiving cavity. The first and second containers are detachably engageable in a generally end-to-end fashion so that the first and second longitudinal axes are aligned to form the two part container.

In another aspect, the present invention is directed to a two part container adapted to separately hold consumable foodstuffs. The two part container includes a first container generally elongated about a first longitudinal axis. The first container includes a first container base. A first container sidewall extends from the base to define a first container mouth. The first container sidewall is formed by inner and outer panels. The inner panel and the first container base define a first foodstuff receiving cavity. The outer panel is generally coextensive with and spaced from the inner panel to define a chamber therebetween. Thermal energy storage material is located in the chamber. A second container is generally elongated about a second longitudinal axis. The second container includes a second container base. A second container sidewall extends from the second container base to define a second container mouth. The second container sidewall and the second container base define a second foodstuff receiving cavity. The first and second containers are detachably engageable in a generally end-to-end fashion so that the first and second longitudinal axes are aligned to form the two part container.

### BRIEF DESCRIPTION OF THE DRAWINGS

The foregoing summary, as well as the following description of the preferred embodiments of the present invention, will be better understood when read in conjunction with the appended drawings. For the purpose of illustrating the invention, there are shown in the drawings embodiments which are presently preferred. It is understood, however, that the invention is not limited to the precise arrangements and instrumentalities shown. In the drawings:

FIG. 1 is a perspective partially broken away view of a first preferred embodiment of the two part container of the present invention; the broken away section makes clearer the first container base 20 and the inner panel 26; the two part container includes a first container having thermal energy storage material therein; the two part container can include thermal energy storage material in the first container and/or in the second container to allow one or both of the first and second containers to be heated and/or chilled;

FIG. 2 is a perspective view of a second preferred embodiment of the two part container of the present invention; the two part container is preferably formed of generally translucent material which can have paper inserts placed therein or therearound to add a desired design;

FIG. 3 is an exploded view of the two part container of FIG. 2;

FIG. 4 is a perspective partially broken away view of a third preferred embodiment of the two part container of the present invention; the broken away section makes clearer the second container base 38 and the inner panel 26; the second container includes thermal energy storage material for heating or cooling the contents therein; however, both the first and second containers can include thermal energy storage material or the thermal energy storage material can be omitted altogether without departing from the scope of the present invention; additionally, when thermal energy storage material is included in either of the first or second containers, the first or second containers may be formed of translucent material to allow the container to have the color of the associated thermal energy storage material;

FIG. 5 is a perspective view of a fourth preferred embodiment of the two part container of the present invention; the two part container has translucent first and second containers and preferably does not use thermal energy storage material therein; and

FIG. 6 is an exploded view of the two part container of FIG. 5.

### DETAILED DESCRIPTION OF THE PREFERRED EMBODIMENT(S)

Certain terminology is used in the following description for convenience only is not limiting. The words “right,” “left,” “top,” and “bottom” designate directions in the drawings to which reference is made. The words “inwardly” and “outwardly” refer to directions toward and away from, respectively, the geometric center of the two part container and designated parts thereof. The word “foodstuff”, as used in the claims and in the corresponding portions of the specification, is defined as including “one or both of liquid foods (such as milk, water, Gatorade, soda or the like) and solid foods (such as cookies, cereal, sandwiches, egg salad, or the like).” The words “a” and “one” are defined as including one or more of the referenced item unless specifically stated otherwise. This terminology includes the words above specifically mentioned, derivatives thereof, and words of similar import.

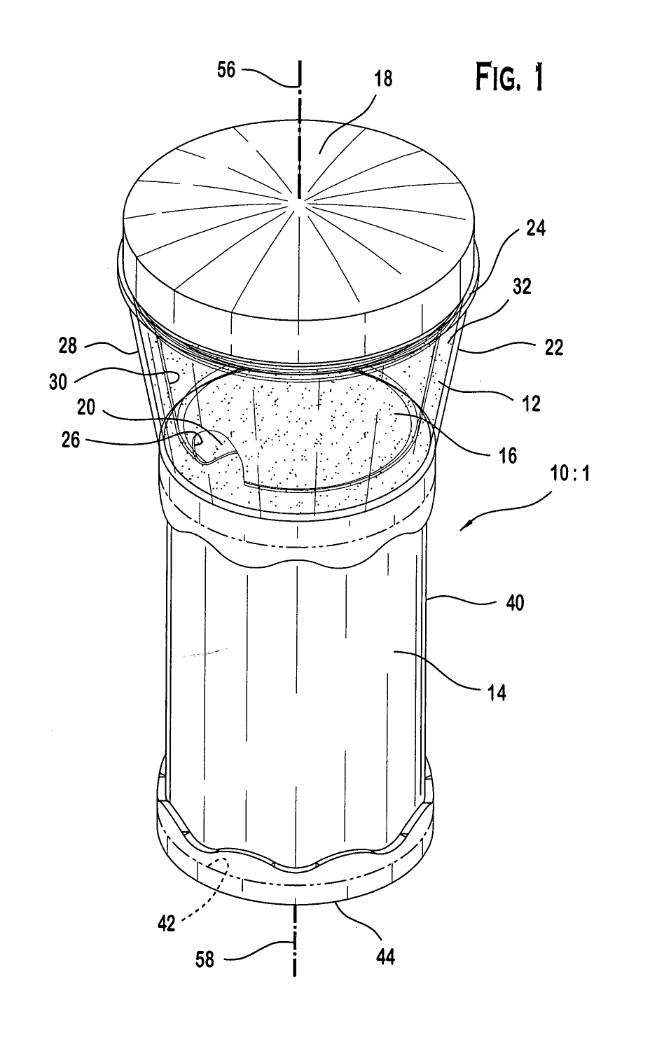

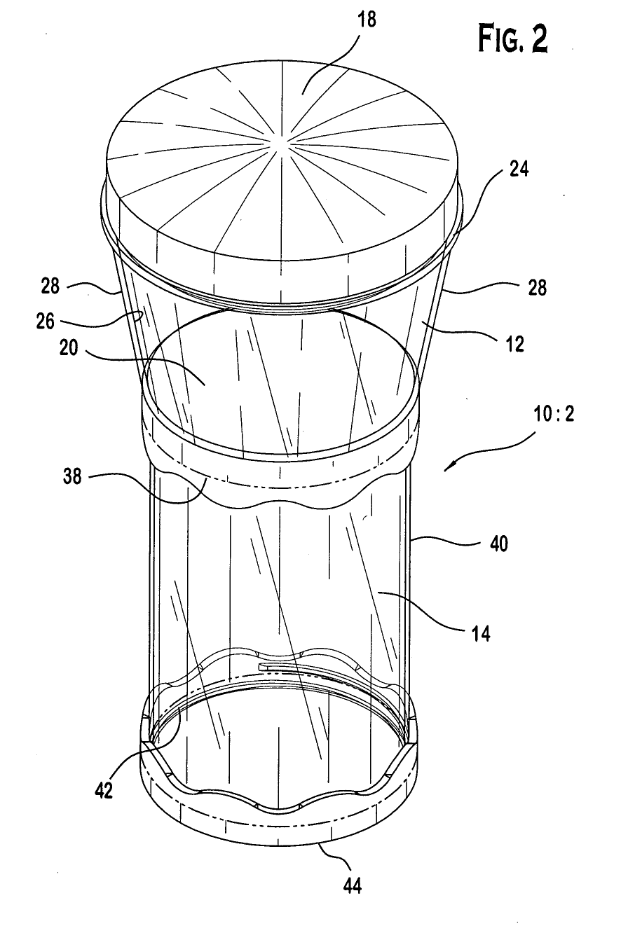

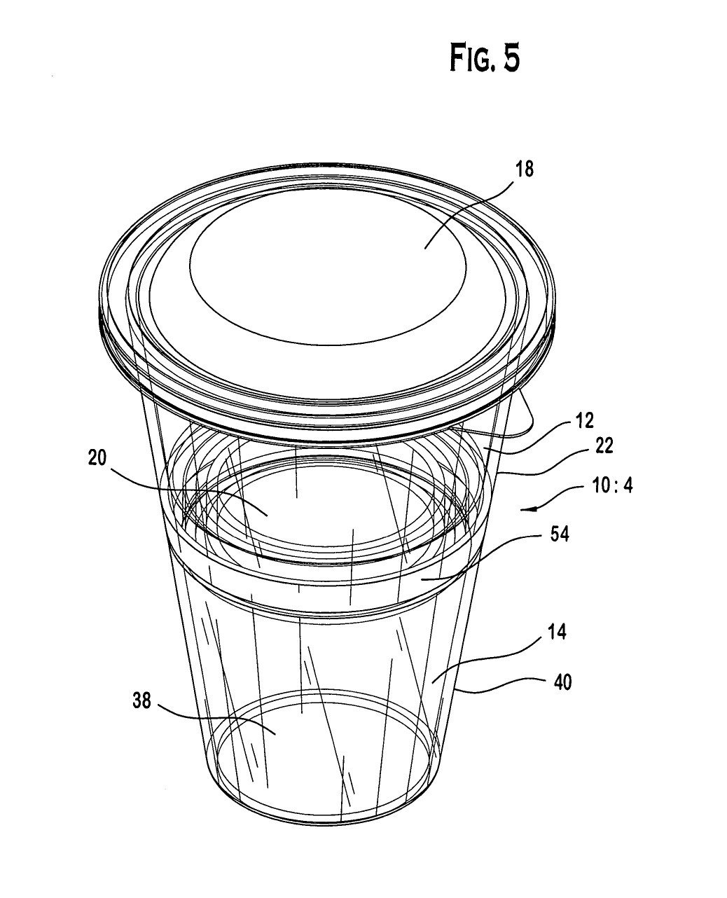

Referring to FIGS. 1-6, wherein like numerals indicate like elements throughout, four preferred embodiments of a two part container are shown and designated 10:1-10:4, respectively. Briefly stated, the two part container 10:1-10:4 provides an improved container for transporting separated foodstuffs. The two part container 10:1-10:4 is preferably also able to keep foodstuffs therein chilled or heated as desired.

While the top container part shown in the drawings is referred to as the first container 12 and the bottom container part shown in the drawings is referred to as the second container 14, such designations are for convenience only. It is understood by those of ordinary skill in the art from this disclosure, that the terms first and second container 12, 14 as used in the claims can each refer to either one of the container parts shown in the drawings. That is, the claimed “second container” may refer to either the top or bottom container part shown in the drawings (while the claimed “first container” refers to the remaining container part shown in the drawings) without departing from the scope of the present invention.

The first and second containers 12, 14 are preferably made of a polymeric material, such as polyethylene, polyethylene terephthalate (PET), polyvinyl chloride (PVC), polyphthalate carbonate (PPC) or any other suitable material. The first and second containers 12, 14 preferably have generally circular cross-sections.

Referring to FIG. 1, a first preferred embodiment of the two part container 10:1 is shown. The two part container 10:1 is adapted to separately hold consumable foodstuffs. The top portion of the two part container 10:1 is formed by a first container 12 that preferably flares generally outwardly from the second container 14 in a conical fashion. The first container 12 includes a first container base 20 which preferably has a generally circular shape. A first container sidewall 22 extends from the base 20 to define a first container mouth 24. The first container sidewall 22 is formed by inner and outer panels 26, 28. The inner and outer panels 26, 28 may be translucent or opaque, as desired.

The inner panel 26 and the first container base 20 define a first foodstuff receiving cavity 30. The outer panel 28 is generally coextensive with and spaced from the inner panel 26 to define a chamber 32 therebetween.

It is preferred that a first diameter 34 of the first container mouth 24 is greater than a second diameter 36 of the first container base 20. It is also preferred that the outer panel 28 of the first container 12 is generally translucent so that the first container 12 generally has the color of the thermal energy storage material 16 located in the chamber 32. The thermal energy storage material 16 is preferably any suitable freezable and/or reheatable material, such as a refreezable gel or the like. It is preferred that the gel can undergo repeated cycles of freezing and thawing in order to provide cooling. Heat storing materials may also be utilized such that the thermal energy storage material can be placed in a microwave oven to allow the thermal energy storage material 16 to provide warmth to foodstuffs.

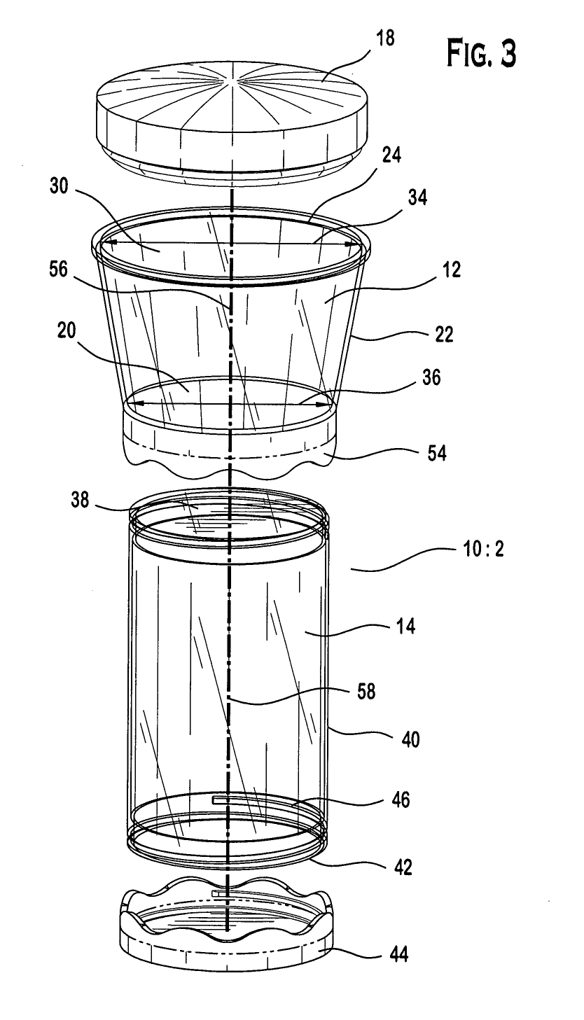

Referring to the first and second embodiments of the two part container 10:1, 10:2 shown in FIGS. 1-3, the two part container 10:1, 10:2 includes a second container 14. The second container 14 preferably has a generally elongated tubular shape. The second container 14 includes a second container base 38. It is preferred that the second container base 38 is generally circular. A second container sidewall 40 extends from the second container base 38 to define a second container mouth 42. Referring specifically to FIG. 3, it is preferable that an end cap 44 form a lid for the second container mouth 42. The end cap 44 is preferably secured to the second container 14 via a threaded connection 46. However, any known means for securing the end cap 44 to the second container 14 can be used without departing from the present invention. For example, the end cap 44 can be secured to the second container 14 via a twist lock mechanism, a snap fit mechanism or the like. While the end cap 44 is shown as a solid lid, those of ordinary skill in the art will appreciate from this disclosure that the end cap 44 can be formed from a drinking lid that incorporates a spout or other mechanism for drinking therefrom.

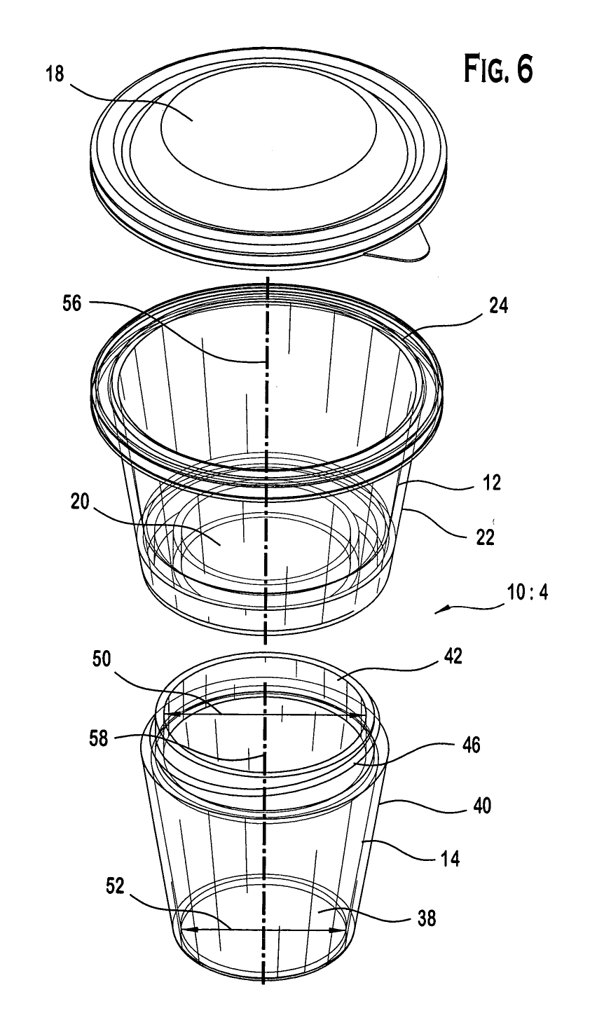

The second container sidewall 40 and the second container base 38 define a second foodstuff receiving cavity 48. Referring to the fourth embodiment of the two part container 10:4 shown in FIG. 6, it is preferable that a third diameter 50 of the second container mouth 42 is greater than a fourth diameter 52 of the second container base 38.

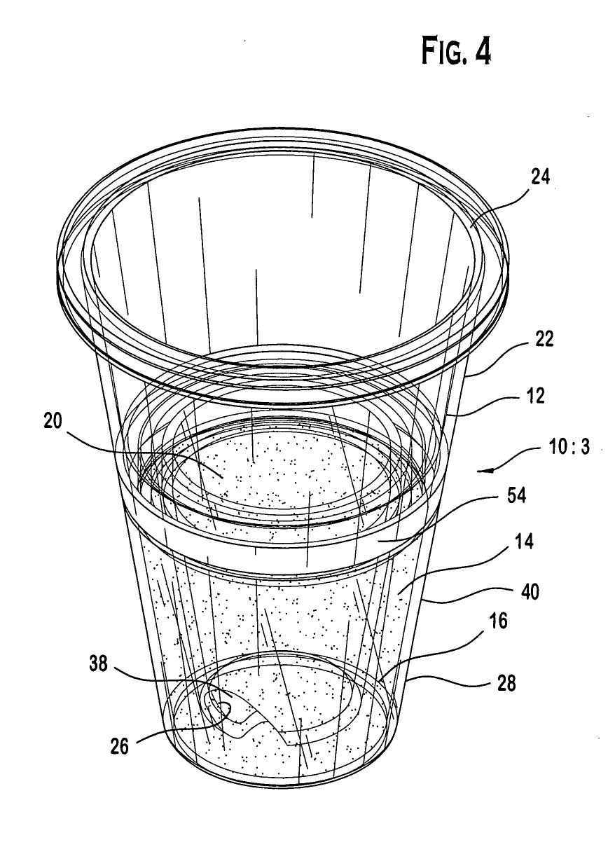

Referring to the two part container 10:1, 10:2 of FIGS. 1-3, it is preferred, but not necessary, that the first and second container mouths 24, 42 are located on generally opposing sides of the two part container 10:1, 10:2 when the first and second containers 12, 14 are attached. However, as shown in FIGS. 4-6, the two part container 10:3, 10:4 may incorporate first and second containers 12, 14 that, when attached, result in the first container 12 providing a lid for the second container 14. Referring to FIGS. 1-3, the second container 14 may have a generally translucent sidewall.

The first and second containers 12, 14 are detachably engageable to form the two part container 10:1-10:4. Referring to FIG. 3, the first and second containers may be detachably engaged via a twist lock mechanism. Alternatively, referring to FIG. 6, the first and second containers 12, 14 may be detachably engageable via a threaded connection 46. Any known connection method can be used without departing from the present invention.

As best shown in FIG. 3, the two part container 10:1 may include a grip member 54 positioned approximate to an interface between the first and second containers 12, 14 and secured generally around the first container base 20 when the first and second containers 12, 14 are attached. This grip member 54 is preferably made of a soft rubber or other material suitable for easy gripping.

Referring to FIGS. 3 and 6, the first container 12 preferably has a first longitudinal axis 56 and the second container preferably has a second longitudinal axis 58. When the first and second containers 12, 14 are detachably engaged, it is preferred that the first and second axes are aligned to position the first and second containers 12, 14 in a generally end-to-end fashion. Referring to FIGS. 1-3, the two part container may be configured for convenient use with milk and cookies. For example, milk can be placed in the first container 12. As shown in FIG. 1, thermal energy storage material can be used to chill the milk prior to consumption. The circular second container 14 is ideal for storing cookies therein. It is preferred that the diameter of each of the cookies is generally the same as an interior diameter of the second container sidewall 40. While the second containers 14 of FIGS. 1-3 are shown as having an end cap 44 which seals a downwardly facing second container mouth 42, those of ordinary skill in the art will appreciate from this disclosure that the second container 14 can have a mouth 42 on an upper end that is sealed by the first container 12 without departing from the scope of the present invention.

Referring now to FIGS. 4-6, the two part container 10:3, 10:4 may be used for milk and cereal. For example, milk is preferably placed in the second container 14 (or may be placed in the second container 12) and thermal energy storage material 16 may be used to keep the milk cool until consumption. Cereal is then positioned in the remaining container part. A foldable spoon can be located in the cereal holding container part so that the consumption of an entire meal does not require carrying additional materials.

While specific types of foodstuffs have been discussed above, those of ordinary skill in the art will appreciate from this disclosure that any type of foodstuffs may be used with the first and second containers without departing from the scope of the present invention. Additionally, a handle or carry strap may be integrated with the two part container 10:1-10:4 without departing from the scope of the present invention.

While the illustrated embodiments of the two part container 10:1-10:4 are shown as being generally cylindrically shaped, those of ordinary skill in the art will appreciate from this disclosure, that the first and containers 12, 14 can have any cross-section without departing from the scope of the present invention. For example, the first and second containers 12, 14 may have a square, triangular, polygonal or a regularly shaped cross-section without departing from the scope of the present invention.

Referring to FIG. 1, one embodiment of the present invention operates as follows. The first container 12 is preferably refrigerated or frozen so that the thermal energy storage material 16 will provide cooling to any foodstuffs therein. Then, milk is poured in the first foodstuff receiving cavity 30 and a lid 18 is placed thereon. While the lid 18 is shown as a solid, flat lid, those of ordinary skill in the art will appreciate from this disclosure that the lid can be formed from a drinking lid that incorporates a spout or other mechanism for drinking therefrom.

The end cap 44 of the second container 14 is removed and cookies are sequentially slid inside the second container 14. Once the second container 14 holds the desired number of cookies, the end cap 14 is secured thereto. The bases 20, 38 of the first and second containers 12, 14 are detachably engaged to form a two part container 10:1.

Once cookies and milk are desired, the second container 14 is separated from the first container 12. The first container 12 is preferably placed on a flat surface, such as a table, and the lid 18 removed. Then, the end cap 44 of the second container 14 is removed so that one or more cookies can be slid out of the second container 14. The cookies can then be dunked in the milk or otherwise consumed therewith.

Referring to FIG. 4, another embodiment of the present invention preferably operates as follows, the second container 14 is preferably refrigerated or frozen so that thermal energy storage material 16 can provide cooling to foodstuffs therein. Then, milk is poured into the second container 14 and the second container 14 is sealed by detachably engaging the first container 12 thereover. Then, cereal is poured into the first container 12. It is preferable that a foldable spoon is placed on top of the cereal for convenience only. A lid 18 is then used to seal the first container 12.

Once consumption of cereal and milk is desired, the first container 12 is removed from the second container 14 and placed on a flat surface such as a table, and a lid 18 is removed therefrom. Then, any spoon or other utensil is removed from the first container 12 and the second container 14 is used to pour milk over the cereal in the first container 12.

While various shapes, configurations, uses, and features have been described above and are shown in the drawings for the various embodiments of the present invention, those of ordinary skill in the art will appreciate from this disclosure that any combination of the above features can be used without departing from the scope of the present invention. Accordingly, it is recognized by those skilled in the art that changes may be made to the above described embodiments of the invention without departing from the broad inventive concept thereof. It is understood, therefore, that this invention is not limited to the particular embodiments disclosed, but is intended to cover all modifications which are within the spirit and scope of the invention as defined by the appended claims and/or shown in the attached drawings.

We claim:

1. A two part container adapted to separately hold consumable foodstuffs, comprising:
a first container, comprising:
a first container base;
a first container sidewall extending from the base to define a first container mouth, the first container sidewall being formed by inner and outer panels, the inner panel and the first container base defining a first foodstuff receiving cavity, the outer panel being generally coextensive with and spaced from the inner panel to define a chamber therebetween; and
thermal energy storage material being located in the chamber;
a second container comprising:
a second container base; and
a second container sidewall extending from the second container base to define a second container mouth, the second container sidewall and the second container base defining a second foodstuff receiving cavity;
wherein the first and second containers are detachably engageable to form the two part container.

2. The two part container of claim 1, wherein the first and second containers are detachably engageable via a twist lock mechanism.

3. The two part container of claim 2, wherein, when the first and second containers are attached, the first container provides a lid for the second container mouth.

4. The two part container of claim 1, wherein, when the first and second containers are attached, the first container provides a lid for the second container mouth.

5. The two part container of claim 4, further comprising a grip member positioned proximate an interface between the first and second containers and secured generally around the first container base when the first and second containers are attached.

6. The two part container of claim 4, wherein a first diameter of the first container mouth is greater than a second diameter of the first container base.

7. The two part container of claim 1, wherein a first diameter of the first container mouth is greater than a second diameter of the first container base.

8. The two part container of claim 1, further comprising:
milk in the first container, wherein the thermal energy storage material is configured to chill the milk;
cookies in the second container, wherein the diameter of each of the cookies is generally the same as an interior diameter of the second container sidewall.

9. The two part container of claim 1, further comprising:
milk in the first container, wherein the thermal energy storage material is configured to chill the milk; and
cereal in the second container.

10. The two part container of claim 9, wherein a first diameter of the first container mouth is greater than a second diameter of the first container base.

11. The two part container of claim 10, wherein the second container has a generally cylindrical, tube shape.

12. The two part container of claim 9, wherein a third diameter of the second container mouth is greater than a fourth diameter of the second container base.

13. The two part container of claim 9, further comprising a foldable spoon locatable in at least one of the first and second containers.

14. The two part container of claim 1, further comprising the first and second container mouths being located on generally opposing sides of the two part container when the first and second containers are attached.

15. The two part container of claim 1, wherein the second panel of the first container is generally translucent so that the first container generally has a color of the thermal energy storage material.

16. The two part container of claim 15, wherein the second container sidewall is generally translucent.

17. The two part container of claim 1, wherein the second container sidewall is generally translucent.

18. A two part container adapted to separately hold consumable foodstuffs, comprising:
a first container having a first longitudinal axis, comprising:
a first container base;
a first container sidewall extending from the base to define a first container mouth, the first container sidewall defining a first foodstuff receiving cavity;
a second container having a second longitudinal axis, comprising:
a second container base; and
a second container sidewall extending from the second container base to define a second container mouth, the second container sidewall and the second container base defining a second foodstuff receiving cavity;
wherein the first and second containers are detachably engageable in a generally end-to-end fashion so that the first and second longitudinal axes are aligned to form the two part container.

19. The two part container of claim 18, wherein the first and second containers are detachably engageable via a twist lock mechanism.

20. The two part container of claim 18, wherein, when the first and second containers are attached, the first container provides a lid for the second container mouth.

21. The two part container of claim 18, further comprising a grip member positioned proximate an interface between the first and second containers and secured generally around the first container base when the first and second containers are attached.

22. The two part container of claim 18, wherein a first diameter of the first container mouth is greater than a second diameter of the first container base.

23. The two part container of claim 22, further comprising:
milk in the first container;
cookies in the second container, wherein the diameter of each of the cookies is generally the same as an interior diameter of the second container sidewall.

24. The two part container of claim 18, further comprising:
milk in the first container; and
cereal in the second container.

25. The two part container of claim 24, wherein a first diameter of the first container mouth is greater than a second diameter of the first container base.

26. The two part container of claim 25, wherein the second container has a generally cylindrical, tube shape.

27. The two part container of claim 18, further comprising the first and second container mouths being located on generally opposing sides of the two part container when the first and second containers are attached.

28. The two part container of claim 18, wherein the first sidewall of the first container is generally translucent.

29. The two part container of claim 28, wherein the second container sidewall is generally translucent.

30. A two part container adapted to separately hold consumable foodstuffs, comprising:
a first container generally elongated about a first longitudinal axis, comprising:
a first container base;
a first container sidewall extending from the base to define a first container mouth, the first container sidewall being formed by inner and outer panels, the inner panel and the first container base defining a first foodstuff receiving cavity, the outer panel being generally coextensive with and spaced from the inner panel to define a chamber therebetween; and
thermal energy storage material being located in the chamber;
a second container generally elongated about a second longitudinal axis, comprising:
a second container base; and
a second container sidewall extending from the second container base to define a second container mouth, the second container sidewall and the second container base defining a second foodstuff receiving cavity;
wherein the first and second containers are detachably engageable in a generally end-to-end fashion so that the first and second longitudinal axes are aligned to form the two part container.
